(19) United States
(12) Patent Application Publication
(10) Pub. No.: US 2026/0064963 A1
(43) Pub. Date: Mar. 5, 2026

(54) Generating Requests For Custom Script Generation

(71) Applicant: Oracle International Corporation, Redwood Shores, CA (US)

(72) Inventors: Dheeraj Kumar Anand, Bangalore (IN); Geordan Robert Drummond, Chester Springs, PA (US)

(73) Assignee: Oracle International Corporation, Redwood Shores, CA (US)

(21) Appl. No.: 18/980,390

(22) Filed: Dec. 13, 2024

Related U.S. Application Data
(60) Provisional application No. 63/691,022, filed on Sep. 5, 2024.

(51) Int. Cl. G06F 40/221

(52) U.S. Cl. CPC G06F 40/221

(57) ABSTRACT

Techniques for generating a markup language-based request for script generation are disclosed. In some embodiments, a system receives user input comprising a target natural language prompt. The system may generate a supplemented prompt comprising the target natural language prompt and example prompt data, the example prompt data comprising (a) a set of example natural language prompts and (b) a set of example markup language-based requests that correspond to the set of example natural language prompts. Next, the system may submit the supplemented prompt to a generative artificial intelligence (AI) model, wherein the generative AI model generates a target markup language-based request based on the supplemented prompt. The system may then receive the target markup language-based request from the generative AI model. Next, the system may submit the target markup language-based request to a script generator, wherein the script generator generates a customized script based on the target markup language-based request.

### CROSS REFERENCE TO RELATED APPLICATIONS

This application claims the benefit of U.S. Provisional Patent Application No. 63/691,022, filed Sep. 5, 2024, and entitled “Markup Language-Based Request Generation By A Generative AI Model For Inputting To A Custom Script Generator,” which is incorporated herein by reference in its entirety as if set forth herein.

### TECHNICAL FIELD

The present disclosure relates to building scripts. In particular, the present disclosure relates to building custom scripts for a database management system using a generative artificial intelligence (AI) model to generate a markup language-based request for inputting into a script generator.

### BACKGROUND

Database management systems have users who use various applications and services to store, manage, and perform computations on databases. Often, the database management systems allow these users to employ numerous out-of-the-box software modules to help configure a software solution to perform a number of tasks. Users who desire even more customization for their tasks rely on scripted database code, also referred to as scripts, for their desired rules. Knowing what rules are desired by their users is both difficult and time-consuming for application and service developers of the database management systems.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for generating a markup language-based request for script generation in accordance with one or more embodiments; and

FIG. 3 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SYSTEM ARCHITECTURE
3. GENERATING A MARKUP LANGUAGE-BASED REQUEST FOR SCRIPT GENERATION
4. COMPUTER NETWORKS AND CLOUD NETWORKS
5. HARDWARE OVERVIEW
6. MISCELLANEOUS; EXTENSIONS

### 1. GENERAL OVERVIEW

Database management systems and other software systems often require that scripts that run within these systems be configured in a specific programming language that is uncommon and unfamiliar to most users. Although a script generator may be used to generate a script for a user, the performance of a script generator (e.g., the accuracy, efficiency, and/or functionality of scripts generated by the script generator) is dependent at least in part on the specificity and clarity of a request submitted to the script generator for the generation of a script. A custom script generator may require requests, e.g., specified in a markup language, that are formatted in accordance with certain syntax, custom tags, and structure(s) that are decipherable by that custom script generator.

One or more embodiments apply a request generator to a natural language prompt submitted by a user to generate a markup language-based request for submission to a custom script generator to generate a custom script. Initially, the system receives a target natural language prompt for the generation of a script. The system submits the target natural language prompt along with example prompt data to the request generator. The request generator may include a generative artificial intelligence (AI) model. The example prompt data includes (a) example natural language prompts and (b) example markup language-based requests that correspond respectively to the example natural language prompts. The example markup language-based requests may be defined in accordance with a particular set of syntax, custom tags, and structure(s). The request generator learns the correct syntax, custom tags, and structure(s) for generating the markup language-based request for submission to a custom script generator based on the example prompt data. Furthermore, the request generator learns the relationships/mapping between the data types in the example natural language prompts and content in the example markup language-based requests that correspond respectively to the example natural language prompts. In an example, the request generator learns how a source, an operation, and a destination specified in a natural language prompt are represented in a markup language-based request. Once trained on the example prompt data, the request generator is applied to the target natural language prompt to generate a target markup language-based request in accordance with the learned syntax, custom tags, and structure(s). The system submits the target markup language-based request to a custom script generator that deciphers the target markup language-based request and generates a custom script. The markup language format of the target markup language-based request ensures that the custom script generator accurately determines elements of the request that form the instructions for the custom script generator. The system then causes the execution of a computer-based process using the custom script, such as by storing, presenting, and/or executing the script generated by the custom script generator.

The term “target” is used herein to indicate data (e.g., prompts) that are input into the system by a user to generate a script and data (e.g., requests) that are generated by the system. In this respect, the term “target” is merely used to help distinguish such data from example data that may be input into the system or generated by the system separately and independently from the features and operations disclosed herein that are directed towards generating a markup language-based request for submission to a custom script generator and generating a custom script.

One or more embodiments described in this Specification and/or recited in the claims may not be included in this General Overview section.

### 2. SYSTEM ARCHITECTURE

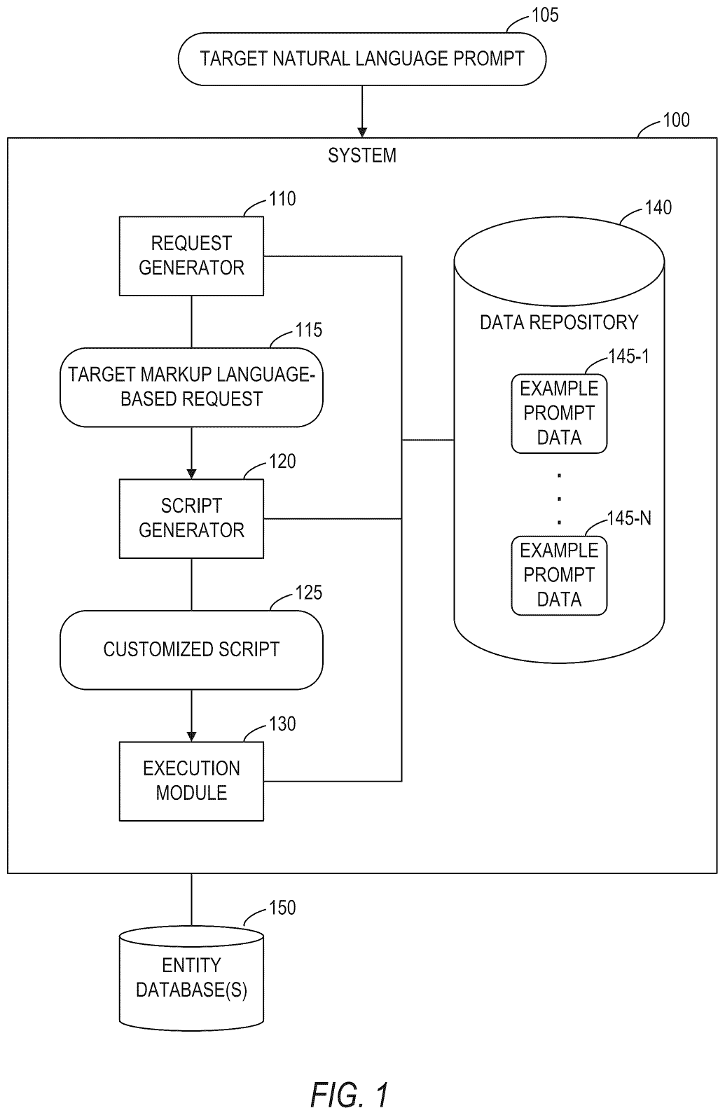

FIG. 1 illustrates a system 100 in accordance with one or more embodiments. As illustrated in FIG. 1, in some embodiments, system 100 includes a request generator 110, a script generator 120, an execution module 130, and a data repository 140. The system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The components of the system 100 may communicate with one another via one or more computer networks. Furthermore, one or more components of the system 100 may be implemented as part of a cloud network. Additional embodiments and/or examples relating to computer networks are described below in Section 4, titled “Computer Networks and Cloud Networks.”

Users of database management systems have their unique and often esoteric requirements and would benefit from having scripts to run their desired rules. Writing such scripts requires technical expertise that can be hard to obtain for these users. Another problem that users face is the lack of insight into restrictions that are being enforced on scripts. The system 100, as described herein, provides a number of advantages, namely, a mechanism through which these users can describe their problem or rule statement in plain English and receive a script (e.g., an Oracle® Essbase™ calc-script based rule) using details embedded in the problem or rule statement. Users would no longer have to worry about how a script should be written or what members and functions are restricted.

To illustrate by way of example, a user may provide a natural language prompt describing a specific rule and request that a script be generated for effectuating the specific rule on a database. Upon receiving the natural language prompt provided by the user, the system 100 appends a number of rule examples to the natural language prompt. The request generator 110 uses these examples to generate a markup language-based request based on the natural language prompt, thereby enabling the script generator 120 to identify individual datasets, or members, along database dimensions and determine which datasets are involved in an expression for moving data from a source member to a destination member. The expression may or may not perform a calculation on the data in addition to moving the data.

In one embodiment, the system 100 operates as a database management system and is coupled with one or more entity database(s) 150 for storing entity data. An entity can have its entity data (e.g., financial data) added/loaded to the entity database(s) 150 by invoking the system 100. It should be noted that the entity may also be the user of services and applications of the system 100, or the user may be a third-party who manages the entity's data on the entity's behalf. As directed by the entity and/or the user, the system 100 may operate as a consolidation engine configured to aggerate the added/loaded entity data and then roll up the aggregated entity data to its parent datasets or even to its grandparent datasets. The system 100 may be configured to rollup scripts into a particular script format (e.g., a calculation scripts format) and then submit the rolled-up scripts to a script engine. The script engine reads the entity data from the entity database(s) 150, executes the rolled-up scripts, and then stores execution results back into the entity database(s) 150.

In an embodiment, the system 100 is configured to receive user input comprising a target natural language prompt 105. The user input is received from a computing device connected to the system 100 (e.g., via a computer network). The target natural language prompt 105 may comprise natural language text that describes a task to be performed by a computer system. The user input may be provided by the user in a variety of different formats. For example, the user of the computing device may provide the user input as text by typing the text using a keyboard of the computing device. The user input may also be provided as audio input by the user speaking into a microphone of the computing device. Other types of user input and other devices for collecting the user input are also within the scope of the present disclosure.

In some embodiments, the request generator 110 is configured to generate a supplemented prompt comprising the target natural language prompt 105 and example prompt data 145. The example prompt data 145 includes (a) a set of example natural language prompts and (b) a set of example markup language-based requests that correspond to the set of example natural language prompts. The request generator 100 may retrieve, or otherwise obtain, the example prompt data 145 from the data repository 140.

In one or more embodiments, the data repository 140 is configured to store a set of multiple distinct example prompt data 145. For example, the data repository 140 may store example prompt data 145-1 through example prompt data 145-N, where N is an integer greater than one. In some embodiments, the data repository 140 is any type of storage unit and/or device (e.g., a file system, database, collection of tables, or any other storage mechanism) for storing data. Furthermore, the data repository 140 may include multiple different storage units and/or devices. The multiple different storage units and/or devices may or may not be of the same type or located at the same physical site.

In some embodiments, the request generator 110 includes a programmed module that is configured to execute, trigger, or otherwise cause generation of a target markup language-based request 115 based on the supplemented prompt. The request generator 110 is configured to submit the supplemented prompt to a generative AI model. The generative AI model is configured to generate the target markup language-based request 115 based on the supplemented prompt. The generative AI model may be implemented and run within the system 100. For example, the generative AI model may be incorporated into the request generator 110. Alternatively, the generative AI model may be implemented and run within another component of the system 100 or within another system that is separate from the system 100 such that communication between the request generator 110 and the other system within which the generative AI model is run is transmitted through one or more network security devices or components (e.g., firewalls, network gateways, or network access control components). The request generator 110 may be configured to receive the target markup language-based request 115 from the generative AI model.

In one or more embodiments, the script generator 120 is configured to generate a customized script 125 based on the target markup language-based request 115 generated by the request generator 110. The script generator 120 may include a programmed module that generates the customized script 125 in accordance with the target markup language-based request 115. The script generator 120 may generate out-of-the-box scripts in various languages (e.g., Oracle® Essbase™ calc-scripts). An out-of-the-box script is a native or built-in script of a product that comes directly from the vendor and works immediately when the product is placed in service. Out-of-the-box scripts may be stored in and accessed from the data repository 140 or the entity database(s) 150.

In some embodiments, the script generator 120 is configured to generate scripts in a proprietary language of a database management system. Accordingly, the customized script 125 generated by the script generator 120 may be scripted in the proprietary language of the database management system. Each script may be a combination of smaller scripts known as templates. Because the out-of-the-box scripts are written in a proprietary script format, an entity cannot customize these scripts per its business needs. Although the script generator 120 allows for the embedding of customized scripts 125 into the-out-of-the-box scripts, this embedding requires the customized scripts 125 to be in a same proprietary script format as the out of the box scripts. Generating such scripts typically requires knowing an uncommon programming language. Some users find such a requirement to be a roadblock to business operations.

In one embodiment, the request generator 110 implements a generative AI model for transforming the target natural language prompt 105 into the markup language-based request 115. The request generator 110 then inputs the target markup language-based request 115 into the script generator 120. In turn, the script generator 120 generates an appropriate customized script 125 for user use based on the target markup language-based request 115. The customized script 125 includes executable computer code or instructions in a programming language (e.g., JavaScript, C++, Essbase Calc, and/or the like). In one or more embodiments, the target natural language prompt 105 is a natural language statement (e.g., in the form of a command or a question) that indicates a specific rule to be constructed into the customized script 125. In contrast, the target markup language-based request 115 includes markup data consisting of one or more statements configured in accordance with a markup language such as, but not limited to, Extensible Markup Language (XML) and JavaScript Object Notation (JSON). The target markup language-based request 115 generally indicates the same specific rule as the target natural language prompt 105 but with added context to help the script generator 120 generate the appropriate customized script 125.

The system 100 combines the target natural language prompt 105 with example prompt data 145 that can be used for training the request generator 110. In one embodiment, the system 100 adds one or more examples included in the example prompt data 145 (e.g., example prompts such as few-shots prompts) to provide added contextual information for a particular format to be used in the customized script 125 when referencing at least a portion (e.g., a table) of the entity database(s) 150. The one or more examples included in the example prompt data 145 can be used by the script generator 120 to properly build the appropriate customized script 125 in accordance with the particular format. The examples included in the example prompt data 145 include markup data for describing a smaller rule that can be combined with the target natural language prompt 105 (and possibly other examples) to generate the target markup language-based request 115.

In one embodiment, the request generator 110 generates the target markup language-based request 115 in a markup language that is compatible with the script generator 120. The target markup language-based request 115, therefore, enhances the target natural language prompt 105 by providing insights into a structure and a syntax of an expression for the entity database 150. Having such insights in the compatible markup language, the script generator 120 is able generate an appropriate customized script 125 for the desired rule. Based on the target markup language-based request 115, the script generator 120 further builds the customized script 125 by identifying individual datasets, or members, along database dimensions in addition to the datasets that are involved in an expression moving data from a source member to a destination member. The expression may perform a calculation on the data in addition to moving the data. In view of the above, having the example prompt data 145 included in the target markup language-based request 115 allows the script generator 120 to build an appropriate customized script 125 for correctly executing the rule outlined in the user's target natural language prompt 105.

In one embodiment, the request generator 110 uses a generative AI model to generate the target markup language-based request 115 for submission to the script generator 120. To illustrate by way of a brief example, a user may enter the target natural language prompt 105 as the following statement in English: “Create a rule that takes the value from Depreciation Building and Improvements Account and writes it to Depreciation Movements within the Land Account.” In response, the request generator 110 proceeds to append the one or more examples from the example prompt data 145 to the target natural language prompt 105 to generate a gen-AI prompt for input to the generative AI model. The examples 108 provide context for the generative AI model to learn the request format that is decipherable by the script generator 120. The generative AI model uses the context to generate the target markup language-based request 115 corresponding to the target natural language prompt 105.

In some embodiments, the example prompt data 145 includes few-shot prompts. Few-shot prompting is a machine learning technique that involves providing an AI model with a small number of examples, also referred to as few-shot prompts, to help the AI model respond to a specific task. A list of example few-shot prompts is provided in the Appendix. Few-shot prompting can be used as a technique to enable in-context learning, where each few-shot prompt serves as conditioning for when the generative AI model generates the target markup language-based request 115 from the target natural language prompt 105.

In an embodiment, the execution module 130 includes a programmed module that is configured to execute, trigger, or otherwise cause execution of a computer-based process using the customized script 125. The execution module 130 may be incorporated into or communicate with a database management system or an enterprise performance management (EPM) system. An EPM system includes a set of business processes and tools that help organizations plan, budget, forecast, and report on their performance. EPM systems integrate and analyze data from many sources, including e-commerce systems, data warehouses, and external data sources. The computer-based process may comprise storing the customized script 125 in a data repository (e.g., within the data repository 140 or within the entity database 150), presenting the customized script 125 on a computing device (e.g., on the computing device from which a user submits the target natural language prompt 105 to the system 100), transmitting the customized script to a computing device (e.g., to the computing device from which a user submits the target natural language prompt 105 to the system 100), or executing the customized script (e.g., as part of a software application). Additionally, or alternatively, the computer-based process may comprise combining the customized script 125 with one or more predefined scripts that are native to a database management system within a predefined software application that is native to the database management system, and then execute the predefined software application. Other types of computer-based processes are also within the scope of the present disclosure.

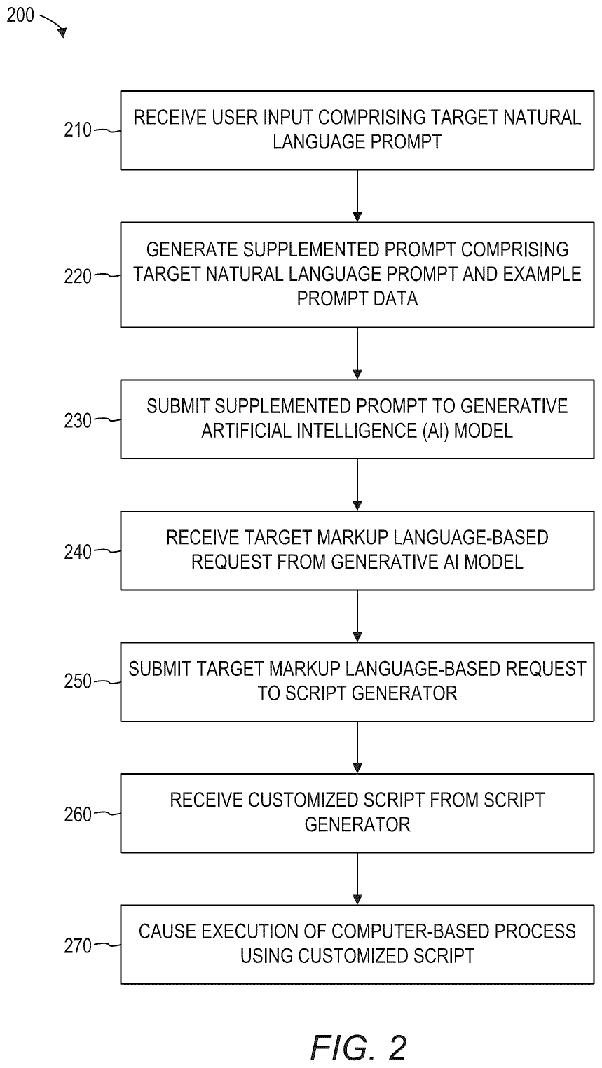

In one or more embodiments, the system 100 refers to hardware and/or software configured to perform operations described herein for generating a markup language-based request for script generation. Examples of operations for generating a markup language-based request for script generation are described below with reference to FIG. 2.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. GENERATING A MARKUP LANGUAGE-BASED REQUEST FOR SCRIPT GENERATION

FIG. 2 illustrates an example set of operations 200 for generating a markup language-based request for script generation in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system 100 receives user input comprising a target natural language prompt (Operation 210). The user input is received from a computing device connected to the system 100 (e.g., via a computer network). The target natural language prompt may comprise natural language text (e.g., a natural language sentence) that describes a task to be performed by a computer system. The user input may be provided by the user in a variety of different formats. For example, the user of the computing device may provide the user input as text by typing the text using a keyboard of the computing device. The user input may also be provided as audio input by the user speaking into a microphone of the computing device. Other types of user input and other devices for collecting the user input are also within the scope of the present disclosure.

In a typical scenario, a user operating a computing device may connect to the system 100 and access system resources by providing credentials. One example resource may be the request generator 110 for a generative script building component (e.g., the script generator 120 of FIG. 1). The request generator 110 may provide an interface through which the user may enter the user input that comprises the target natural language prompt 105. In this scenario, when the user needs a script to effectuate a specific rule, the user enters a natural language sentence as a general statement of the specific rule and an initial starting point for its conversion into the desired script. One example embodiment of the target natural language prompt 105 is the following natural language sentence: “Create a rule that takes the value from Depreciation Building and Improvements Account and writes it to Depreciation Movements within Land Account.” The above prompt conveys the user's intention for the desired script, which is to retrieve a value from member “Depreciation Building and Improvements Account” and then write that value to a combination of members “Depreciation Movements” and “Land Account.” Such a combination may be called a Point of View (POV).

In one or more embodiments, the system 100 generates a supplemented prompt comprising the target natural language prompt 105 and example prompt data 145 (Operation 220). The example prompt data comprises (a) a set of example natural language prompts and (b) a set of example markup language-based requests that correspond to the set of example natural language prompts. The system 100 may generate the supplemented prompt by appending the example prompt data 145 to the target natural language prompt 105. In some embodiments, the set of example markup language-based requests are written in a language that supports markup tags. For example, the set of example markup language-based requests may be written in XML or JSON. However, other languages that support markup tags are also within the scope of the present disclosure.

Referring to the above-mentioned example, the system 100 may combine the above natural language sentence of the target natural language prompt 105 with the example prompt data 145 for a number of purposes. One example purpose for such a combination is to effectively condition the request generator 110 to generate a target markup language-based request 115 that expresses the desired script format. As described herein, the request generator 110 can leverage a generative AI model to produce a target markup language-based request 115 for the script generator 120 by first providing such a model with one or more example prompts such as few shots prompts.

In one embodiment, the system 100 generates the target markup language-based request 115 in a markup language (e.g., XML, JSON) that is compatible with the script generator 120. The target markup language-based request 115 provides insights into a structure and a syntax of an expression for the entity database 150. Having such insights in the compatible markup language, the script generator 120 is able generate an appropriate customized script 125 for the desired rule. Based on the target markup language-based request 115, the script generator 120 may further build the customized script 125 by identifying individual datasets, or members, along database dimensions in addition to the datasets that are involved in an expression moving data from a source member to a destination member. The expression may perform a calculation on the data in addition to moving the data. Having example prompt data 145 included in the target markup language-based request 115 allows the script generator 120 to build an appropriate customized script 125 for correctly executing the rule outlined in the target natural language prompt 105. Examples of example prompt data 145 are provided below.

Example 1, as follows, is XML data for natural language sentence “calculate D201, D202 from S201, S202” and one example few-shots prompt that can be used to enhance the user prompt and train the request generator to produce resultant XML data as the markup language-based prompt.

(Example 1) XML for the sentence “calculate D201, D202 from S201, S202” is:

```
<params>
  <calc>
      <exp>
          <src>
          <pov>
        <mem>S201</mem>
        <mem>S202</mem>
          </pov>
        </src>
          <dst>
            <pov>
        <mem>D201</mem>
        <mem>D202</mem>
          </pov>
          </dst>
    </exp>
  </calc>
</params>
```

Similar to Example 1, the following XML data for Example 2 and Example 3 also are example few shots prompts:

(Example 2) XML for the sentence “Create a rule that takes the value from S203. S204 and S205 and writes it to D203. D204, and D205 within the D206” is:

```
<params>
  <calc>
    <exp>
        <src>
          <mem>S203</mem>
          <mem>S204</mem>
          <mem>S205</mem>
        </src>
        <dst>
          <mem>D203</mem>
          <mem>D204</mem>
          <mem>D205</mem>
          <mem>D206</mem>
        </dst>
    </exp>
  </calc>
</params>
```

(Example 3) XML for the sentence “initialize and calculate D251, D252 from S251, S252” is:

```
<params>
  <calc>
    <exp>
      <init>true</true>
      <src>
        <pov>
          <mem>S251</mem>
          <mem>S252</mem>
        </pov>
      </src>
      <dst>
        <pov>
          <mem>D251</mem>
          <mem>D252</mem>
        </pov>
      </dst>
    </exp>
  </calc>
</params>
```

Example 2 includes XML data for the natural language sentence “Create a rule that takes the value from S203, S204, and S205 and writes it to D203, D204, and D205 within the D206,” and Example 3 includes XML data for the natural language sentence “initialize and calculate D251, D252 from S251, S252” as printed in the above paragraph.

A number of different nodes are indicated in the above example few-shot prompts. The following descriptions explain how these nodes are being used in the XML data for each example.

First, a <mem/> node specifies a member for a particular dimension in the entity database(s) 150. In the target natural language prompt 105, the user's desired rule is to take a value from the ‘Depreciation Building and Improvements Account’ member in the account dimension and then write that value to a combination of a ‘Depreciation Movements’ member from the movement dimension and a ‘Land Account’ member from the account dimension. For instance, the request generator 110 may use Example 1 to identify such members in the target natural language prompt 105 and correctly map each member to one of the <mem/> nodes. A typical service or application in the system 100 may have at least 10 to 12 dimensions of entity data, and each dimension could have certain members.

Second, a <pov> node represents a combination of members and may be called a cell. To illustrate by way of example, assume an example entity database 150 has six dimensions: Scenario: [Members: Actual, Budget, and so on]; Years: [Members: FY24, FY25, and so on]; Period: [Members: Jan., Feb., and so on]; Entity: [Members: North America, East Sales, and so on]; Account: [Members: Depreciation Building and Improvements Account, Land Account, and so on]; and Movement: [Members: No Movement, Depreciation Movements, and so on]. To automate the entry of data to the entity database 150, the system 100 may generate a corresponding script that defines at least one member from each dimension. The combination of such members is called a POV node. In another embodiment, the system 100 may retrieve the data to enter into the entity database(s) 150 from data forms instead of or in addition to scripts. The system 100 may receive a data form via an interface to the user's device or a plug-in to a third-party application. One example plug-in may be an XLS plug-in, called Smart View, for a productivity application.

Regarding the nodes <dst/>, <src/>, <opr/>, and <exp/>, any calculation that is done via scripts may have an expression (<exp/> node) containing a source (<src/> node) and a destination (<dst/> node). The source and destination may have an assignment operation (<opr/> node) between them. As an example, the request generator 110 can map nodes <dst/>, <src/>, <opr/>, and <exp/> to members Depreciation Movements->Land Account=Depreciation Building and Improvements Account.

Fourth, a <calc/> node specifies calculations of which each calculation includes expressions. An expression is something that assigns some value to a destination (left-hand side) from the source (right-hand side).

Fifth, a <params/> node specifies parameters from which the script generator builds a script. These parameters may be passed to the script generator 120 as XML data starting with tags <params></params>.

In generating the supplemented prompt, the system 100 may select the set of example natural language prompts from a plurality of example natural language prompts. In response to the selecting of the set of example natural language prompts, the system 100 may combine the set of example natural language prompts with the target natural language prompt 105 to generate the supplemented prompt. In some embodiments, the system 100 selects the set of example natural language prompts from a plurality of example natural language prompts based on a comparison of the set of example natural language prompts with the target natural language prompt 105. For example, the system 100 may determine a user intent of the target natural language prompt 105 and then select the example natural language prompts that correspond to the user intent of the target natural language prompt 105. In an embodiment, the system 100 uses a support vector machine (SVM) to determine the intent of the target natural language prompt 105. An SVM is a machine learning algorithm that uses supervised learning models to solve complex classification, regression, and outlier detection problems by performing optimal data transformations that determine boundaries between data points based on predefined classes, labels, or outputs. The system 100 may compare the user intent of the target natural language prompt 105 with corresponding user intents of the example natural language prompts to determine which example natural language prompts to select for inclusion in the supplemented prompt.

In addition to selecting example natural language prompts to include in the supplemented prompt based on a comparison of user intents, the system 100 may also select a static base set of example natural language prompts to include in the supplemented prompt independent from any consideration of user intent. In some embodiments, the system 100 may select a combination of the static base set of example natural language prompts (that are always selected for inclusion regardless of the specific target natural language prompt 105 being processed) and the dynamic set of example natural language prompts (that are dynamically selected based on the determination of user intent). For example, assume that the plurality of example natural language prompts includes the following categories of few-shot prompts:
(1) Base-including 10 few-show prompts
(2) Addition—including 3 few-shot prompts
(3) Subtraction—including 2 few-shot prompts
(4) Cash Flow—including 4 few-shot prompts
(5) Balance—including 2 few-shot prompts

In the example above, if the system 100 determines that the user intent of the target natural language prompt 105 is Cash Flow Addition, then the system 100 will select 10 base prompts, 3 Addition prompts, and 4 Cash Flow prompts. The Base few-shot prompts are always selected for inclusion regardless of the target natural language prompt 105, and the remaining few-shot prompts depend upon the determined user intent of the target natural language prompt 105.

In some embodiments, the system 100 submits the supplemented prompt to a generative AI model (Operation 230). In one example, the system 100 feeds the supplemented prompt as input into the generative AI model. In an embodiment in which the generative AI model is external to the system 100, the system 100 transmits the supplemented prompt via a network connection (e.g., the Internet) to the external system in which the generative AI model is running as part of a request to generate a target markup language-based request. In response to the system 100 submitting the supplemented prompt to the generative AI model, the generative AI model generates the target markup language-based request based on the supplemented prompt.

When the system 100 applies the generative AI model to the supplemented prompt, the generative AI model generates the target markup language-based request. Using the example prompt data 145 (e.g., the example few-shots prompts), the system 100 can condition the generative AI model to learn how to produce XML data, or other markup language data, for the target natural language prompt. In the example discussed above in which the target natural language prompt 105 includes the natural language sentence “Create a rule that takes the value from Depreciation Building and Improvements Account and writes it to Depreciation Movements within Land Account,” the generative AI model may generate the following target markup language-based request:

```
<params>
  <calc>
    <exp>
      <src>
        <pov>
          <mem>Depreciation Building and Improvements
        Account</mem>
        </pov>
      </src>
      <dst>
        <pov>
          <mem>Depreciation Movements</mem>
          <mem>Land Account</mem>
        </pov>
      </dst>
    </exp>
  </calc>
</params>
```

In an embodiment, the system 100 receives the target markup language-based request from the generative AI model (Operation 240). In one or more embodiments, the target markup language-based request is written in a language that supports markup tags. For example, the target markup language-based request may be written in XML or JSON. However, other languages that support markup tags are also within the scope of the present disclosure.

In one or more embodiments, the system 100 submits the target markup language-based request 115 to a script generator 120 (Operation 250). The script generator 120 generates a customized script 125 based on the target markup language-based request 115. The script generator 120 may generate the customized script 125 using the target markup language-based request 115 in a variety of different ways.

In some embodiments, the script generator 120 generates the customized script 125 by determining, based on the target markup language-based request 115, a process for processing data, a source data structure from which to extract the data to be processed by the process, and a destination data structure to which to load the processed data, which may be indicated by the target markup language-based request 115 based on the target natural language prompt 105. In such embodiments, the script generator 120 determines a first set of dimensions of the source data structure that are identified in the target natural language prompt 105. The script generator 120 also determines a second set of dimensions of the destination data structure that are not identified in the target natural language prompt 105 based on a knowledge base or on the target markup language-based request 115, using the knowledge base or details included in the target markup language-based request 115 to determine key details missing from the target natural language prompt 105. The script generator 120 then configures the customized script to assign corresponding values to the second set of dimensions of the destination data structure using one or more rules. The script generator 120 may determine the one or more rules based on the process determined by the script generator 120 based on the target markup language-based request 115.

In one or more embodiments, the script generator 120 generates the customized script 125 by determining, based on the target markup language-based request 115, a process for processing data, a source data structure from which to extract the data to be processed by the process, and a destination data structure to which to load the processed data, which may be indicated by the target markup language-based request 115 based on the target natural language prompt 105. The script generator 120 may also determine a configuration for an execution mode of the process based on a knowledge base or on the target markup language-based request 115. The execution mode controls a runtime behavior of the process. For example, the script generator 120 may determine to use a bottom-up calculation configuration in which, during runtime, the process determines which existing data blocks need to be calculated before it calculates a database, and then calculates only the blocks that need to be calculated during the full database calculation. Other types of configurations for the execution mode of the process are also within the scope of the present disclosure. In some embodiments, the script generator 120 configures the script to apply the determined configuration for the execution mode of the process.

An example of how the example few-shots prompts of the above-discussed Example 1, Example 2, and Example 3 affect the target markup language-based request 115 generated by the request generator 110 and, eventually, the customized script 125 generated by the script generator 120 is provided below. Referring to the above desired rule of taking a value from Depreciation Building and Improvements Account and writing it to Depreciation Movements within Land Account, the target markup language-based request 115 maps at least the Depreciation Building and Improvements Account member to a first example POV node and at least the Depreciation Movements within Land Account members to a second example POV node. The target markup language-based request 115 also maps the first example POV node to an example source node and the second example POV node to an example destination node. The target markup language-based request 115 further specifies an example expression node that includes the above source and destination nodes and an assignment operation between the source and destination nodes. By doing so, the target markup language-based request 115 conveys insights that the script generator 120 can leverage to correctly generate an appropriate customized script 125.

Based on the above target markup language-based request 115, the script generator 120 can generate an appropriate customized script 125 to satisfy the above user-desired rule of taking a value from Depreciation Building and Improvements Account and write it to Depreciation Movements within Land Account. The target markup language-based request 115 directs the script generator 120 to builds the appropriate customized script 125 from at least the following example expression:

Depreciation Movements -> Land Account = Depreciation Building and Improvements
Account.

The target markup language-based request 115 also directs the script generator 120 to build the customized script 125 where the destination node should be a POV node, and the source node can either be a POV node, a number, or a combination of both the POV node and the number. Alternative expressions for the above example expression may be as follows:

```
  Depreciation Movements -> Land Account = 200,000; or
  Depreciation Movements -> Land Account = Depreciation Building and Improvements
Account + 200,000.
```

In an example, the system 100 generates the target markup language-based request 115 to include a destination POV node with a member from the account dimension and a member from the movement dimension. The system 100 generates the target markup language-based request 115 to include a source POV with a member from only the account dimension. In other embodiments, the system 100 generates the target markup language-based request 115 to include a source POV node with a member from the dimensions defined in the entity database 150. If needed, the system 100 can acquire additional member definitions for the target markup language-based request 115. For instance, if the target natural language prompt 105 does not define the members from each dimension, the request generator 110 may use domain knowledge to select missing members from any remaining dimensions. To illustrate with reference to the above example entity database 150, the request generator 110 may generate XML data for defining an example POV node as a combination of members Actual, FY24, Jan., East Sales, Depreciation Building and Improvements Account, No Movement.

To further illustrate with reference to the above example entity database 150, consider an example where the user wants to plan a budget of $100,000 for Depreciation Building and Improvements Account for FY24 in January (i.e., member Jan.) where East Sales are depreciations, then the user desires a script that defines the second example POV node from members Budget, FY24, Jan., East Sales, Depreciation Building and Improvements Account, Depreciation Movements. Based on a target markup language-based request 115 that is generated with names for the above members, the script generator 120 can build an appropriate customized script 125 for the above example first by defining an example POV node from the combination of members Budget, FY24, Jan., East Sales, Depreciation Building and Improvements Account, Depreciation Movements and then by defining an expression with a cross dimensional operator between members of the POV node. As an example, the appropriate customized script 125 may include the following example expression:
Budget->FY24->Jan.->East Sales->Depreciation Building and Improvements Account->Depreciation Movements.

Assuming the user also wants a script configured to save $100,000 to the above POV node, the script generator 120 can use the target markup language-based request 115 to build the customized script 125 with the following example expression:
Budget->FY24->Jan.->East Sales->Depreciation Building and Improvements Account->Depreciation Movements=100,000.

Another way for the script generator 120 to build a customized script 125 that defines the above POV node is as follows:
FIX (Budget, FY24, Jan., East Sales, Depreciation Building and Improvements Account’) Depreciation Movements=100,000; ENDFIX.

In some embodiments, the system 100 receives the customized script 125 from the script generator 120 (Operation 260). The customized script 125 may be scripted in a proprietary language (e.g., JavaScript, C++, Essbase Calc, and/or the like) of a computer system. For example, the customized script 125 may be scripted in a proprietary programming language of a database management system. The customized script 125 includes executable computer code or instructions in the proprietary programming language.

In an embodiment, the system 100 causes execution of a computer-based process using the customized script (Operation 270). For example, in response to receiving the customized script 125 from the script generator 120, the system 100 may perform a number of actions and then terminate the set of operations illustrated in FIG. 2. The system 100 may store the customized script 125 in a data repository such as in a local data store. The system 100 may present the customized script 125 to the user via an interface to the user's computing device. The system 100 may transmit the customized script 125 to the user's computing device or to another computing device such as a third-party resource. The system 100 may execute the customized script 125. For example, the system 100 may execute the customized script 125 on the entity database 150. The system 100 may also combine the customized script 125 with one or more predefined scripts that are native to a database management system within a predefined software application that is native to the database management system and then execute the predefined software application. The executing of the predefined software application may comprise executing the customized script 125 and the one or more predefined scripts. Other computer-based processes are also within the scope of the present disclosure.

### 4. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In laaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 5. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

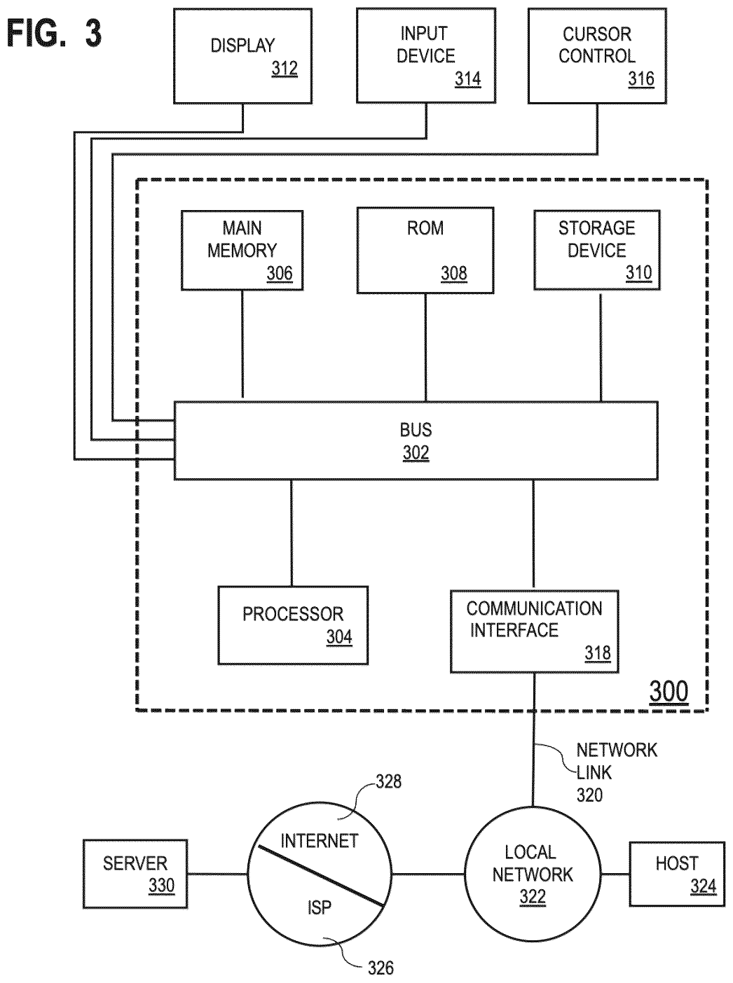

For example, FIG. 3 is a block diagram that illustrates a computer system 300 upon which an embodiment of the disclosure may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or a Solid State Drive (SSD) is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### 6. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
receiving user input comprising a target natural language prompt;
generating a supplemented prompt comprising the target natural language prompt and example prompt data, the example prompt data comprising (a) a set of example natural language prompts and (b) a set of example markup language-based requests that correspond to the set of example natural language prompts;
submitting the supplemented prompt to a generative artificial intelligence (AI) model, wherein the generative AI model generates a target markup language-based request based on the supplemented prompt;
receiving the target markup language-based request from the generative AI model;
submitting the target markup language-based request to a script generator, wherein the script generator generates a customized script based on the target markup language-based request;
receiving the customized script from the script generator; and
causing execution of a computer-based process using the customized script.

2. The media of claim 1, wherein the generating the supplemented prompt comprises:
selecting the set of example natural language prompts from a plurality of example natural language prompts based on a comparison of the set of example natural language prompts with the target natural language prompt; and
responsive to the selecting of the set of example natural language prompts, combining the set of example natural language prompts with the target natural language prompt to generate the supplemented prompt.

3. The media of claim 1, wherein:
the set of example markup language-based requests written in a language that supports markup tags; and
the target markup language-based request written in a language that supports markup tags.

4. The media of claim 3, wherein the language that supports markup tags comprises Extensible Markup Language (XML) or JavaScript Object Notation (JSON).

5. The media of claim 1, wherein the script generator generates the customized script by at least:
determining, based on the target markup language-based request, a process for processing data, a source data structure from which to extract the data to be processed by the process, and a destination data structure to which to load the processed data;
determining a first set of dimensions of the source data structure that are identified in the target natural language prompt;
determining a second set of dimensions of the destination data structure that are not identified in the target natural language prompt based on a knowledge base or on the target markup language-based request; and
configuring the customized script to assign corresponding values to the second set of dimensions of the destination data structure using one or more rules.

6. The media of claim 1, wherein the script generator generates the customized script by at least:
determining, based on the target markup language-based request, a process for processing data, a source data structure from which to extract the data to be processed by the process, and a destination data structure to which to load the processed data;
determining a configuration for an execution mode of the process based on a knowledge base or on the target markup language-based request, wherein the execution mode controls a runtime behavior of the process; and
configuring the script to apply the configuration for the execution mode of the process.

7. The media of claim 1, wherein the customized script is scripted in a proprietary language of a database management system.

8. The media of claim 1, wherein the computer-based process comprises storing the customized script in a data repository, presenting the customized script on a computing device, transmitting the customized script to a computing device, or executing the customized script.

9. The media of claim 1, wherein the computer-based process comprises:
combining the customized script with one or more predefined scripts that are native to a database management system within a predefined software application that is native to the database management system; and
executing the predefined software application, wherein the executing of the predefined software application comprises executing the customized script and the one or more predefined scripts.

10. A method performed by at least one device including a hardware processor, the method comprising:
receiving user input comprising a target natural language prompt;
generating a supplemented prompt comprising the target natural language prompt and example prompt data, the example prompt data comprising (a) a set of example natural language prompts and (b) a set of example markup language-based requests that correspond to the set of example natural language prompts;
submitting the supplemented prompt to a generative artificial intelligence (AI) model, wherein the generative AI model generates a target markup language-based request based on the supplemented prompt;
receiving the target markup language-based request from the generative AI model;
submitting the target markup language-based request to a script generator, wherein the script generator generates a customized script based on the target markup language-based request;
receiving the customized script from the script generator; and
causing execution of a computer-based process using the customized script.

11. The method of claim 10, wherein the generating the supplemented prompt comprises:
selecting the set of example natural language prompts from a plurality of example natural language prompts based on a comparison of the set of example natural language prompts with the target natural language prompt; and
responsive to the selecting of the set of example natural language prompts, combining the set of example natural language prompts with the target natural language prompt to generate the supplemented prompt.

12. The method of claim 10, wherein:
the set of example markup language-based requests written in a language that supports markup tags; and
the target markup language-based request written in a language that supports markup tags.

13. The method of claim 12, the language that supports markup tags comprises XML or JSON.

14. The method of claim 10, wherein the script generator generates the customized script by at least:
determining, based on the target markup language-based request, a process for processing data, a source data structure from which to extract the data to be processed by the process, and a destination data structure to which to load the processed data;
determining a first set of dimensions of the source data structure that are identified in the target natural language prompt;
determining a second set of dimensions of the destination data structure that are not identified in the target natural language prompt based on a knowledge base or on the target markup language-based request; and
configuring the customized script to assign corresponding values to the second set of dimensions of the destination data structure using one or more rules.

15. The method of claim 10, wherein the script generator generates the customized script by at least:
determining, based on the target markup language-based request, a process for processing data, a source data structure from which to extract the data to be processed by the process, and a destination data structure to which to load the processed data;
determining a configuration for an execution mode of the process based on a knowledge base or on the target markup language-based request, wherein the execution mode controls a runtime behavior of the process; and
configuring the script to apply the configuration for the execution mode of the process.

16. The method of claim 10, wherein the customized script is scripted in a proprietary language of a database management system.

17. The method of claim 10, wherein the computer-based process comprises storing the customized script in a data repository, presenting the customized script on a computing device, transmitting the customized script to a computing device, or executing the customized script.

18. The method of claim 10, wherein the computer-based process comprises:
combining the customized script with one or more predefined scripts that are native to a database management system within a predefined software application that is native to the database management system; and
executing the predefined software application, wherein the executing of the predefined software application comprises executing the customized script and the one or more predefined scripts.

19. A system comprising:
at least one device including a hardware processor;
the system being configured to perform operations comprising:
receiving user input comprising a target natural language prompt;
generating a supplemented prompt comprising the target natural language prompt and example prompt data, the example prompt data comprising (a) a set of example natural language prompts and (b) a set of example markup language-based requests that correspond to the set of example natural language prompts;
submitting the supplemented prompt to a generative artificial intelligence (AI) model, wherein the generative AI model generates a target markup language-based request based on the supplemented prompt;
receiving the target markup language-based request from the generative AI model;
submitting the target markup language-based request to a script generator, wherein the script generator generates a customized script based on the target markup language-based request;
receiving the customized script from the script generator; and
causing execution of a computer-based process using the customized script.

20. The system of claim 19, wherein the generating the supplemented prompt comprises:
selecting the set of example natural language prompts from a plurality of example natural language prompts based on a comparison of the set of example natural language prompts with the target natural language prompt; and
responsive to the selecting of the set of example natural language prompts, combining the set of example natural language prompts with the target natural language prompt to generate the supplemented prompt.
